(19) United States
(12) Patent Application Publication
(10) Pub. No.: US 2015/0067221 A1
(43) Pub. Date: Mar. 5, 2015

(54) DATA TRANSFER APPARATUS AND METHOD

(71) Applicant: FUJITSU LIMITED, Kawasaki-shi (JP)

(72) Inventor: Hirokazu Fujitani, Numazu (JP)

(21) Appl. No.: 14/338,374

(22) Filed: Jul. 23, 2014

(30) Foreign Application Priority Data
Sep. 5, 2013 (JP) 2013-184304

(51) Int. Cl. G06F 13/40

(52) U.S. Cl. CPC G06F 13/4068
USPC 710/301

(57) ABSTRACT

A data transfer apparatus includes a first connection unit, a second connection unit, a first storage unit, a second storage unit and a processor. The first connection unit is connected to a network card. The second connection unit is connected to a board on which a processor and a memory are mounted. The processor obtains an identifier of the network card connected to the first connection unit. The first storage unit stores a first identifier obtained by the processor. The second storage unit stores a second identifier different from the first identifier obtained by the processor when the first identifier is stored in the first storage unit. When the second identifier is assigned to data input from the first connection unit, the processor replaces the second identifier assigned to the data with the first identifier, and outputs the data via the second connection unit.

### CROSS-REFERENCE TO RELATED APPLICATION

This application is based upon and claims the benefit of priority of the prior Japanese Patent Application No. 2013-184304, filed on Sep. 5, 2013, the entire contents of which are incorporated herein by reference.

### FIELD

The embodiments discussed herein are related to a technique for transferring data.

### BACKGROUND

An iSCSI storage system that transmits and receives data to and from a remote storage unit by using an iSCSI protocol has been put into practical use. iSCSI is an abbreviation for Internet Small Computer System Interface.

An iSCSI storage system is a system implemented by combining diverse devices such as a processor unit, a storage unit, a storage switch, a management switch and the like.

The processor unit included in the iSCSI storage system has a network card used to communicate with another unit. In the processor unit, a network card is replaced when a fault occurs on the network card. At this time, a user sets a MAC address (hereinafter referred to also as an identifier) of the replaced network card in an OS of the processor unit. The MAC address is an abbreviation for Media Access Control address. The OS is an abbreviation for Operating System.

As a related technique, a technique by which a computer registers also a MAC address after replacement to a local MAC address management table in addition to a MAC address before the replacement when the MAC address is changed due to the replacement of a communication control board and the computer makes both of the MAC addresses before and after the replacement available, thereby eliminating the need of another computer to be aware of the MAC address change is known.

Also as another related technique, a technique by which a network controller includes a main body having a function to connect to a network and the network controller includes a memory that stores a MAC address for uniquely identifying a LAN card in a communication network, a board on which the memory is mounted, and a connector that can plug and remove the mounting board into and from the main body is known (for example, Japanese Laid-open Patent Publication No. 10-65702 and Japanese Laid-open Patent Publication No. 2011-55400).

### SUMMARY

According to an aspect of the embodiments, A data transfer apparatus includes a first connection unit, a second connection unit, a first storage unit, a second storage unit and a processor. The first connection unit is connected to a network card. The second connection unit is connected to a board on which a processor and a memory are mounted. The processor obtains an identifier of the network card connected to the first connection unit. The first storage unit stores a first identifier obtained by the processor. The second storage unit stores a second identifier different from the first identifier obtained by the processor when the first identifier is stored in the first storage unit. When the second identifier is assigned to data input from the first connection unit, the processor replaces the second identifier assigned to the data with the first identifier, and outputs the data via the second connection unit.

The object and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF DRAWINGS

FIG. 1 illustrates an implementation example of a storage system;

FIG. 2 illustrates an implementation example of a processor unit;

FIG. 3 illustrates an implementation example of a processor unit to which a data transfer apparatus according to an embodiment is applied;

FIG. 4 is a functional block diagram illustrating an implementation example of the data transfer apparatus;

FIG. 5 illustrates an example of a packet;

FIG. 6 illustrates an example of a first identification table;

FIG. 7 illustrates an example of a second identification table;

FIG. 8 is a flowchart illustrating an identifier storage process;

FIG. 9 is a flowchart illustrating a process executed when a packet is input from a first connection unit;

FIG. 10 is a flowchart illustrating a process executed when a packet is input from a second connection unit; and

FIG. 11 is a block diagram illustrating an implementation example of the data transfer apparatus.

### DESCRIPTION OF EMBODIMENTS

A data transfer apparatus has a risk such that a user erroneously sets an identifier in a setting of the identifier of a replaced network card.

Accordingly, an embodiment provides a technique for preventing an error from being made in a setting of an identifier of a network card.

A data transfer apparatus according to the embodiment is described.

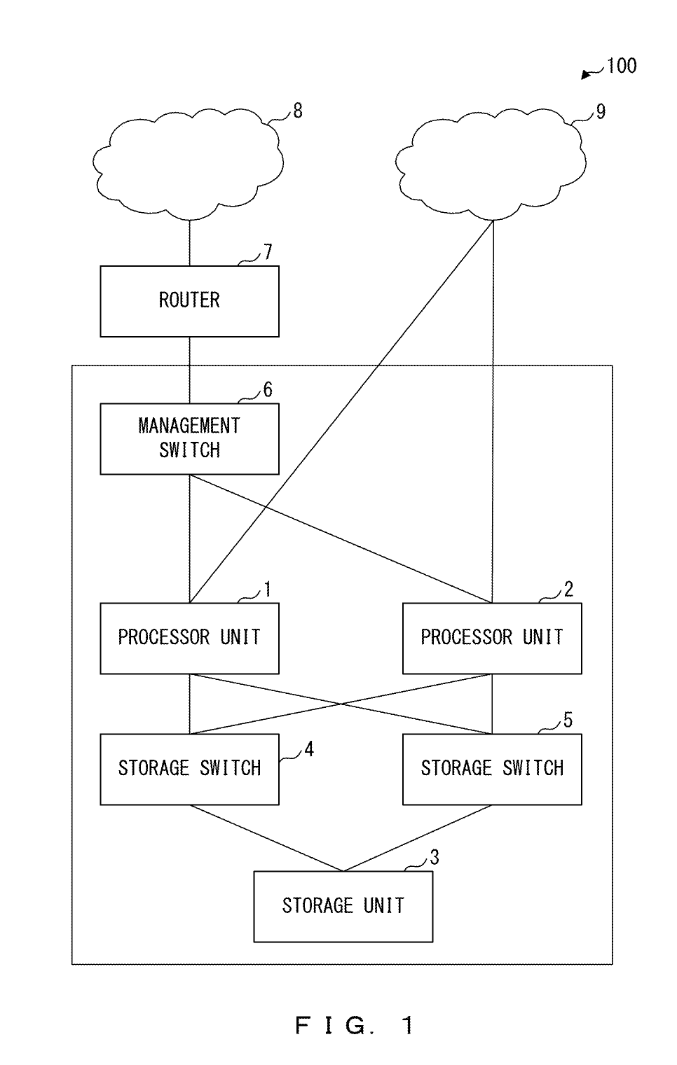

FIG. 1 illustrates an implementation example of a storage system.

The storage system including a processor unit, in which the data transfer apparatus according to the embodiment is used, is described with reference to FIG. 1.

The storage system 100 includes, for example, a processor unit 1, a processor unit 2, a storage unit 3, a storage switch 4, a storage switch 5, a management switch 6 and a router 7. The storage system 100 is connected, for example, to a management network 8 and an operation network 9 of the user, and transmits and receives various types of data to and from the respective networks. A configuration of the storage system 100 is not limited to that illustrated in FIG. 1. The storage system 100 may include a plurality of components in order to make the system redundant.

In the following description, the processor unit 1 and the processor unit 2 have the same configuration. Therefore, the processor unit 1 is described as an example.

The processor unit 1 receives management data from a terminal in the management network 8 via the router 7 and the management switch 6. Then, the processor unit 1 transmits the management data to the storage unit 3 via the storage switch 4 or the storage switch 5 based on an address attached to the management data. The storage switch 4 and the storage switch 5 may be, for example, a LAN switch.

Additionally, the processor unit 1 receives operation data from a terminal in the operation network 9. Then, the processor unit 1 transmits the operation data to the storage unit 3 via the storage switch 4 or the storage switch 5 based on an address attached to the operation data.

Furthermore, the processor unit 1 receives a data read request from a terminal in each of the networks. Then, the processor unit 1 transmits the data read request to the storage unit 3 via the storage switch 4 or the storage switch 5 based on an address attached to the data read request. As a result, the processor unit 1 receives the data read from the storage unit 3. Then, the processor unit 1 transmits the received data to the terminal in each of the networks.

Still further, for example, when a fault occurs in the processor unit 2, the processor unit 1 executes a process that the processor unit 2 is requested to execute instead of the processor unit 2. Moreover, for example, when a fault occurs in the processor unit 1, the processor unit 2 executes a process that the processor unit 1 is requested to execute instead of the processor unit 1. In this way, the storage system 100 is made redundant by employing the two processor units.

The processor unit 1 and the processor unit 2 are communicatively coupled. The processor unit 1 and the processor unit 2 may monitor a counterpart operation and may share setup information. As a result, the processor unit 1 can detect a fault of the processor unit 2 and can function as a backup of the processor unit 2. In the meantime, the processor unit 2 can detect a fault of the processor unit 1, and can function as a backup of the processor unit 1.

The processor unit 1 uses a network card in a communication made between the processor unit 2 and the storage unit 3. The processor unit 1 may use, for example, an iSCSI protocol in the communication made between the processor unit 2 and the storage unit 3.

When a write request is attached to data received from the processor unit 1, the storage unit 3 stores the received data according to the request. Moreover, upon receipt of a read request from the processor unit 1, the storage unit 3 reads stored data according to the received read request, and transmits the read data to the processor unit 1. The storage unit 3 may be, for example, a RAID device. RAID is an abbreviation for Redundant Arrays of Inexpensive Disks.

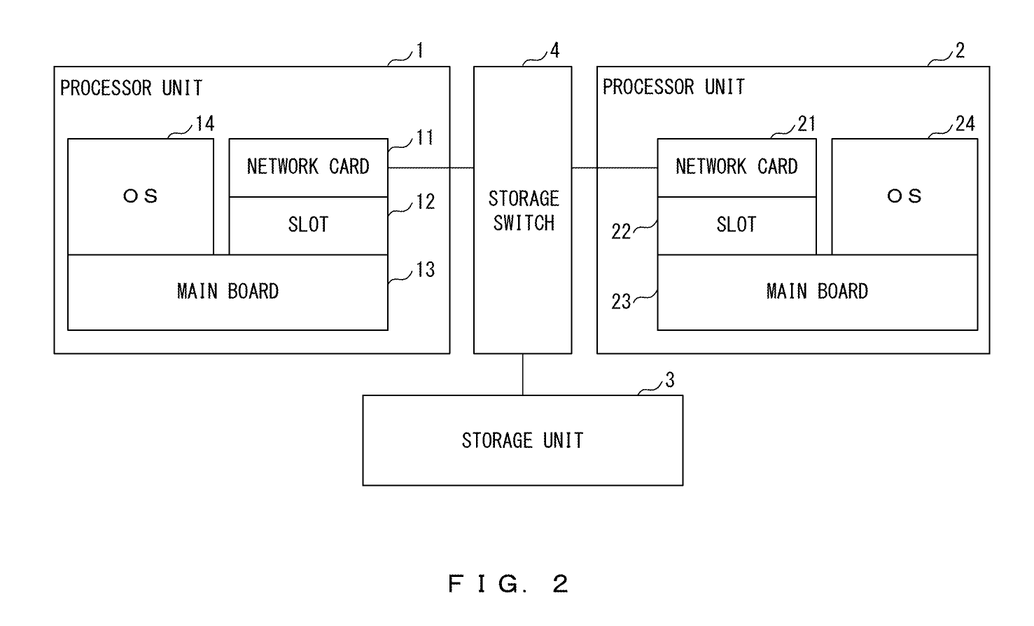

FIG. 2 illustrates an implementation example of the processor unit.

The following description refers to a processor unit, which will be described later and to which a data transfer apparatus according to an embodiment is not applied. Since the processor unit 1 and the processor unit 2 have the same configuration, the processor unit 1 is described as an example. In FIG. 2, the same components as those of FIG. 1 are denoted with the same reference numerals, and their descriptions are omitted.

The processor unit 1 includes, for example, a network card 11, a slot 12, a main board 13, and an OS 14.

The network card 11 connects the processor unit 1 to a network including the processor unit 2, the storage unit 3, and the storage switch 4. When data generated by the processor unit 1 is input, the network card 11 transmits the input data to the network. Moreover, upon receipt of data transmitted from another device, the network card 11 inputs the data to the processor unit 1. The network card 11 may be, for example, a LAN card. LAN is an abbreviation for Local Area Network.

The slot 12 connects between the network card 11 and the main board 13. The slot 12 may be, for example, a PCIe slot. PCIe is an abbreviation for Peripheral Component Interconnect Express.

The main board 13 is a substrate on which various types of components, which configure the processor unit 1, are mounted. On the main board 13, for example, a control circuit (processor) such as a CPU, an FPGA or the like, storage devices (memories) such as an HDD, a ROM, a RAM, an EEPROM and the like are mounted. FPGA is an abbreviation for Field Programmable Gate Array. ROM is an abbreviation for Read Only Memory. RAM is an abbreviation for Random Access Memory. EEPROM is an abbreviation for Electrically Erasable Programmable Read-Only Memory.

The OS 14 manages operations of the processor unit 1. In the OS 14, a user sets a MAC address of the network card 11 connected to the processor unit 1. Accordingly, in the processor unit 1, for example, when a fault occurs in the network card 11 and the network card 11 is replaced with another network card 11, a user manually sets a MAC address of the replaced network card 11 in the OS 14. As described above, the processor unit 1 has a problem in that a setting of a MAC address of the network card 11 is bothersome at the time of maintenance and replacement of the network card 11. Moreover, a MAC address setting with a manual input has a risk such that a user erroneously inputs a MAC address.

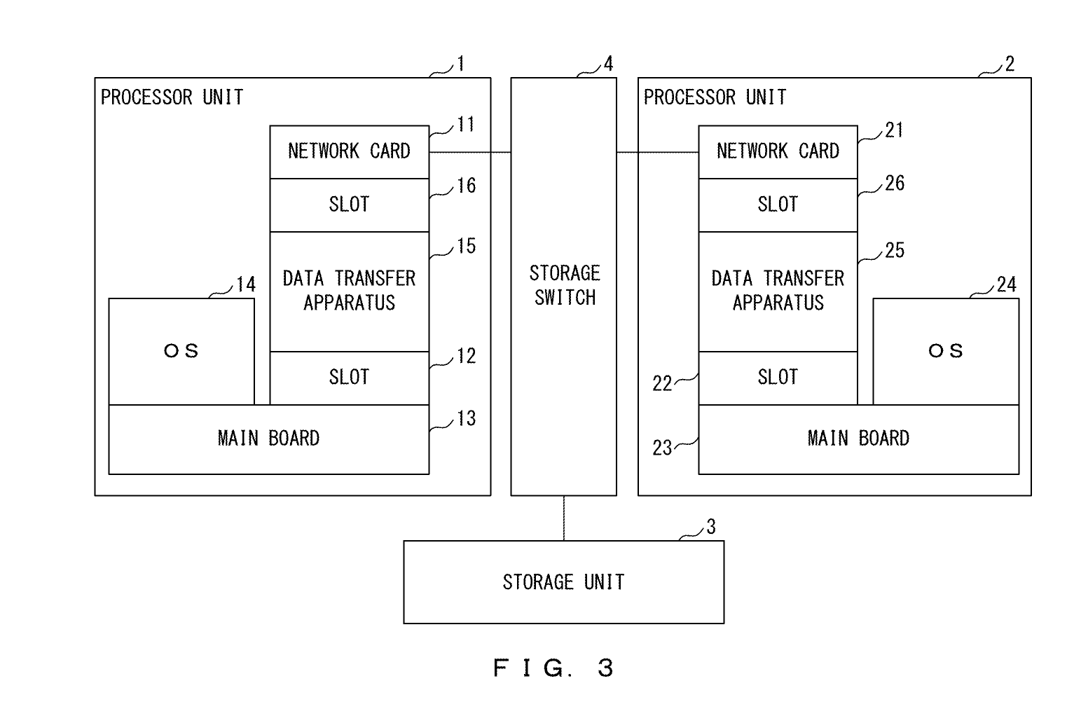

FIG. 3 illustrates an implementation example of a processor unit to which the data transfer apparatus according to the embodiment is applied.

The processor unit to which the data transfer apparatus according to the embodiment is applied is described with reference to FIG. 3. Since the processor unit 1 and the processor unit 2 have the same configuration, the processor unit 1 is described as an example. In FIG. 3, the same components as those of FIG. 2 are denoted with the same reference numerals, and their descriptions are omitted.

The processor unit 1 includes the data transfer apparatus 15 between the network card 11 and the main board 13.

The data transfer apparatus 15 is connected to the main board 13 via the slot 12. The data transfer apparatus 15 is also connected to the network card 11 via the slot 16. The slot 16 may be, for example, a PCIe slot. Moreover, the slot 16 may be included in the data transfer apparatus 15.

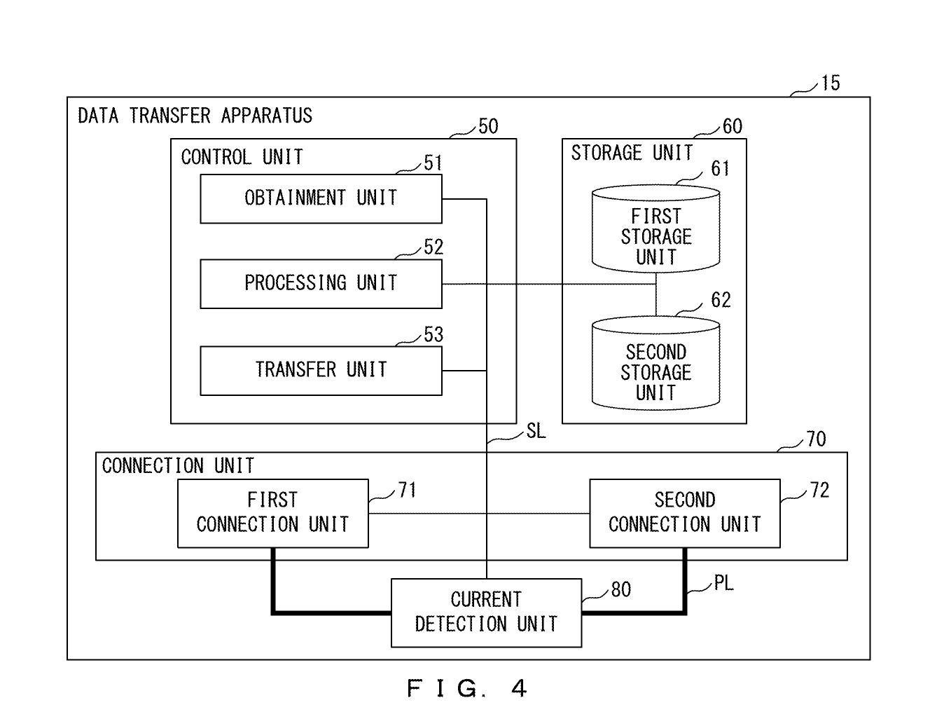

FIG. 4 is a functional block diagram illustrating an implementation example of the data transfer apparatus.

Functions of the data transfer apparatus 15 according to the embodiment are described with reference to FIG. 4. The following description assumes that the data transfer apparatus 15 is connected to the main board 13 via the slot 12 as illustrated in FIG. 3. Also assume that the data transfer apparatus 15 is connected to the network card 11 via the slot 16 as illustrated in FIG. 3.

The data transfer apparatus 15 has a control unit 50, a storage unit 60, a connection unit 70, and a current detection unit 80.

The control unit 50 includes an obtainment unit 51, a processing unit 52, and a transfer unit 53. The storage unit 60 includes a first storage unit 61 and a second storage unit 62. The connection unit 70 includes a first connection unit 71 and a second connection unit 72.

The obtainment unit 51 obtains an identifier of the network card 11 connected to the first connection unit 71. The obtainment unit 51 may obtain the identifier of the network card 11, for example, by using a PCI Express protocol. The identifier of the network card 11 is, for example, a MAC address.

When a dummy identifier different from the identifier of the network card 11 is stored in the first storage unit 61, the processing unit 52 stores an identifier obtained by the obtainment unit 51 in the second storage unit 62 as a second identifier. Here, the dummy identifier may be, for example, a MAC address different from a MAC address that can be possibly used in the network card 11 or the main board 13.

When the first identifier is stored in the first storage unit 61, the processing unit 52 stores an identifier different from the first identifier obtained by the obtainment unit 51 in the second storage unit 62 as the second identifier.

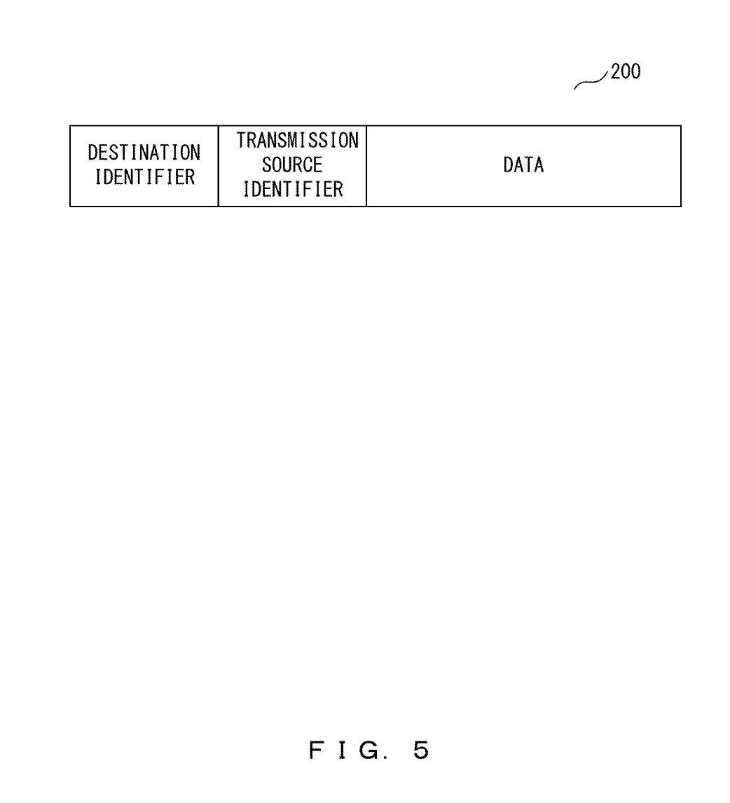

When an identifier assigned to data input from the second connection unit 72 is different from an identifier stored in the first storage unit 61, the processing unit 52 stores the identifier assigned to the data input from the second connection unit 72 in the first storage unit 61 as the first identifier. For example, when a packet 200 illustrated in FIG. 5 is input from the second connection unit 72, the processing unit 52 references a transmission source identifier that indicates an identifier set in the OS 14 as the identifier assigned to the data input from the second connection unit 72. The identifier stored in the first storage unit 61 is, for example, a first identifier stored at preceding time, or a dummy identifier. The data input from the second connection unit 72 is, for example, data that is generated by the OS 14 and transmitted to another device via the network card 11.

When no identifier is stored in the first storage unit 61, the processing unit 52 stores the identifier obtained by the obtainment unit 51 in the first storage unit 61 as the first identifier.

When the second identifier is assigned to data input from the first connection unit 71, the transfer unit 53 performs a control for replacing the second identifier assigned to the data with the first identifier and for outputting the data to the main board 13 via the second connection unit 72. For example, when the packet 200 illustrated in FIG. 5 is input from the first connection unit 71, the transfer unit 53 references a destination identifier that indicates an identifier set in a destination device as the identifier assigned to the data input from the first connection unit 71. When the destination identifier is the second identifier that is different from the first identifier stored in the first storage unit 61 and stored in the second storage unit 62, the transfer unit 53 replaces the destination identifier of the data with the first identifier. The data input from the first connection unit 71 is, for example, data that is transmitted from another device and received by the processor unit 1 via the network card 11.

Additionally, when an identifier different from the second identifier is assigned to the data input from the first connection unit 71, the transfer unit 53 discards the data. For example, when the packet 200 illustrated in FIG. 5 is input from the first connection unit 71, the transfer unit 53 references the destination identifier that indicates the identifier set in the destination device as the identifier assigned to the data input from the first connection unit 71. When the destination identifier is different from the second identifier, the transfer unit 53 discards the data.

Furthermore, when the second identifier is not stored in the second storage unit 62 and the first identifier is assigned to the data input from the first connection unit 72, the transfer unit 53 does not replace the first identifier assigned to the data. Then, the transfer unit 53 performs a control for outputting the data to the main board 13 via the second connection unit 72. For example, when the packet 200 illustrated in FIG. 5 is input from the first connection unit 71, the transfer unit 53 references the destination identifier that indicates the identifier set in the destination device as the identifier assigned to the data input from the first connection unit 71. When the second identifier is not stored in the second storage unit 62 and the destination identifier is the same as the first identifier stored in the first storage unit, the transfer unit 53 performs a control for outputting the data to the main board 13 without replacing the destination identifier.

When the second identifier is not stored in the second storage unit 62 and an identifier different from the first identifier is assigned to the data input from the first connection unit 71, the transfer unit 53 discards the data. For example, when the packet 200 illustrated in FIG. 5 is input from the first connection unit 71, the transfer unit 53 references the destination identifier that indicates the identifier set in the destination device as the identifier assigned to the data input from the first connection unit 71. When the second identifier is not stored in the second storage unit 62 and the destination identifier is different from the first identifier stored in the first storage unit, the transfer unit 53 discards the data.

Additionally, when the first identifier is assigned to the data input from the second connection unit 72, the transfer unit 53 performs a control for replacing the first identifier assigned to the data with the second identifier and for outputting the data to the network card 11 via the first connection unit 71. For example, when the packet 200 illustrated in FIG. 5 is input from the second connection unit 72, the transfer unit 53 references the transfer source identifier as the identifier assigned to the data input from the second connection unit 72. When the transfer source identifier is the same as the first identifier stored in the first storage unit, the transfer unit 53 performs a control for replacing the transfer source identifier with the second identifier stored in the second storage unit 62 and for outputting the data to the network card 11.

Furthermore, when the second identifier is not stored in the second storage unit 62 and the first identifier is assigned to the data input from the second connection unit 72, the transfer unit 53 performs a control for outputting the data to the network card 11 via the first connection unit 71 without replacing the first identifier assigned to the data. For example, when the packet 200 illustrated in FIG. 5 is input from the second connection unit 72, the transfer unit 53 references the transfer source identifier as the identifier assigned to the data input from the second connection unit 72. When the second identifier is not stored in the second storage unit 62, the transfer unit 53 performs a control for outputting the data to the network card 11 without replacing the transfer source identifier.

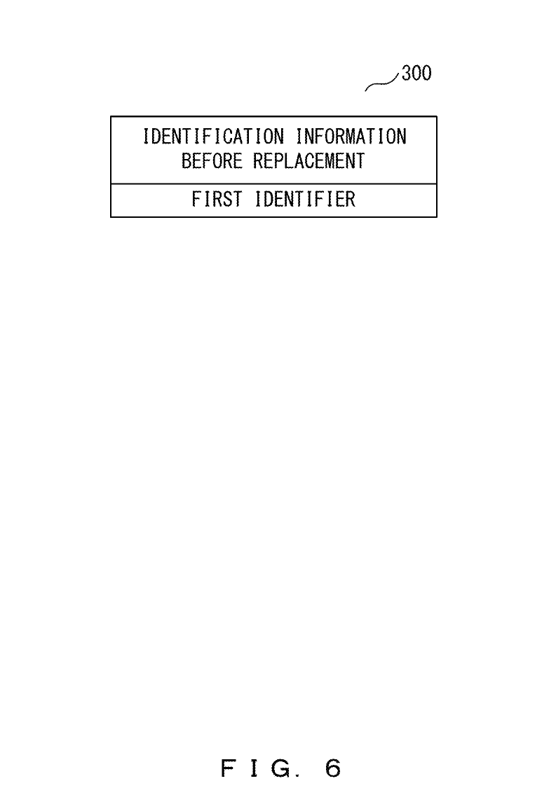

The first storage unit 61 stores the first identifier obtained by the obtainment unit 51. The first identifier is an identifier of, for example, the network card 11 that is initially connected to the data transfer apparatus 15. For example, when the data transfer apparatus 15 is connected to the processor unit 1 at factory shipment, the data transfer apparatus 15 is connected in a state where no identifier is stored in the first storage unit 61. Thus, the data transfer apparatus 15 can obtain the identifier of the network card 11 connected at startup of the processor unit 1, and can store the obtained identifier in the first storage unit 61 as the first identifier. In the first storage unit 61, for example, a first identification table 300 for storing the first identifier may be stored as identification information before replacement, which indicates the network card 11 that is initially connected to the data transfer apparatus 15, as illustrated in FIG. 6. In the following description, the network card 11 that is initially connected to the data transfer apparatus 15 is referred to also as the network card 11 before replacement.

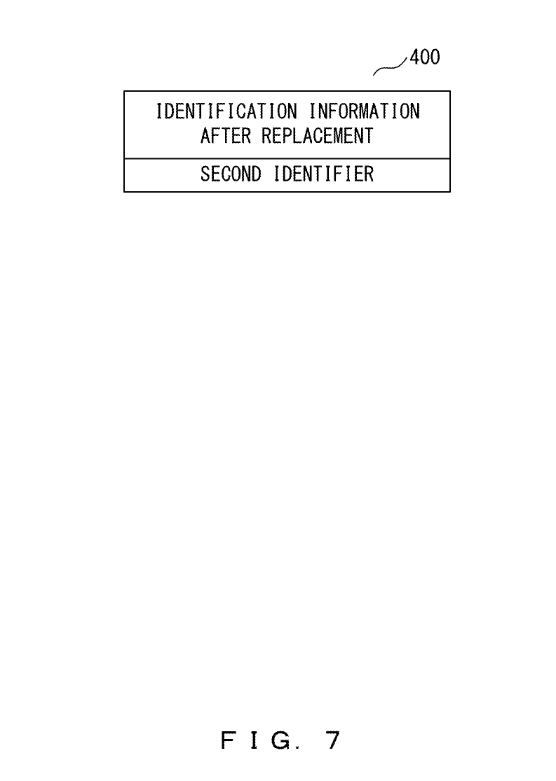

Additionally, the first storage unit 61 may store a dummy identifier different from the identifier of the network card 11. The dummy identifier may be, for example, prestored by a user. The data transfer apparatus 15 is connected, for example, in a state where the dummy identifier is stored in the first storage unit 61 when the data transfer apparatus 15 is connected to the processor unit 1 at the time of maintenance and replacement of the network card 11. Thus, the data transfer apparatus 15 can obtain the identifier of the network card 11, which is connected at startup of the processor unit 1 and maintained and replaced, and can store the obtained identifier in the second storage unit 62 as the second identifier. In the second storage unit 62, for example, a second identification table 400 for storing the second identifier may be stored as identification information after replacement, which indicates the network card 11 connected to the data transfer apparatus 15 at the time of maintenance and replacement, as illustrated in FIG. 7. The maintenance and replacement are operations for connecting another network card 11 to the processor unit 1 as a replacement for the network card 11 before replacement, for example, when a fault occurs in the network card 11 before replacement. In the following description, the network card 11 connected to the data transfer device 15 at the time of maintenance and replacement is referred to also as a network card 11 after replacement.

When the first identifier is stored in the first storage unit 61, the second storage unit 62 stores an identifier different from the first identifier obtained by the obtainment unit 51 as the second identifier.

Furthermore, when a dummy identifier is stored in the first storage unit 61, the second storage unit 62 stores an identifier obtained by the obtainment unit 51 as the second identifier.

The first connection unit 71 is connected to the network card 11. The first connection unit 71 inputs data input from the network card 11 to the data transfer apparatus 15. Moreover, the first connection unit 71 inputs data input from the data transfer apparatus 15 to the network card 11.

The second connection unit 72 is connected to the main board 13. The second connection unit 72 inputs data input from the main board 13 to the data transfer apparatus 15. Moreover, the second connection unit 72 inputs data input from the data transfer apparatus 15 to the main board 13.

The current detection unit 80 detects a current supplied from the main board 13 to the network card 11 via the data transfer apparatus 15. When the current has been supplied to the network card 11, the current detection unit 80 notifies the obtainment unit 51 that the current has been supplied to the network card 11. When the current of a specified size or more is supplied from the main board 13 to the network card 11 via the data transfer apparatus 15, the current detection unit 80 may notify the obtainment unit 51 that the current has been supplied. Moreover, the current detection unit 80 may notify the obtainment unit 51 of the detected current value. Additionally, when the current value of a certain threshold value or more is notified from the current detection unit 80, the obtainment unit 51 may determine that the current has been supplied from the main board 13 to the network card 11 via the data transfer apparatus 15.

A signal line SL connects among the components of the data transfer apparatus 15, and conveys a signal exchanged among the components.

A current line PL connects among the first connection unit 71, the current detection unit 80 and the second connection unit 72, and outputs a current input from the main board 13 to the network card 11.

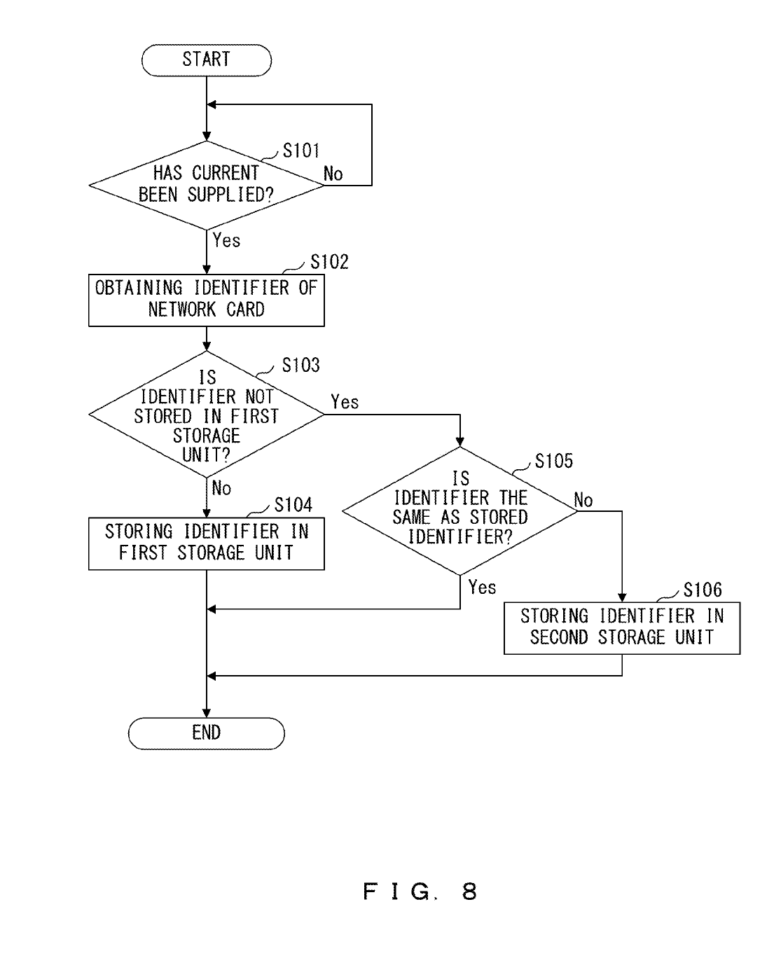

FIG. 8 is a flowchart illustrating an identifier storage process.

The identifier storage process is described with reference to FIG. 8. The following description assumes that the network card 11 is connected to the processor unit 1 as illustrated in FIG. 3.

For example, at startup of the processor unit 1, the obtainment unit 51 determines whether or not a current has been supplied from the main board 13 to the network card 11 via the data transfer apparatus 15 (S101). After startup of the processor unit 1, the obtainment unit 51 waits until a notification indicating that the current has been supplied to the network card 11 is made from the current detection unit (“NO” in S101).

When the notification indicating that the current has been supplied to the network card 11 is made from the current detection unit 80, the obtainment unit 51 obtains the identifier of the network card 11 (S102). The obtainment unit 51 may transmit, for example, an identifier obtainment request to the network card 11 when the notification indicating that the current has been supplied to the network card 11 is made from the current detection unit 80. When the identifier obtainment request is made, the network card 11 may notify the obtainment unit 51 of the identifier assigned to the network card 11.

The processing unit 52 determines whether or not an identifier is stored in the first storage unit 61 when the identifier is obtained by the obtainment unit 51 (S103).

When the identifier is not stored in the first storage unit 61 (“NO” in S103), the processing unit 52 stores the identifier obtained by the obtainment unit 51 in the first storage unit as the first identifier (S104). Then, the data transfer apparatus 15 terminates the identifier storage process. The time when the identifier is not stored in the first storage unit 61 of the data transfer apparatus 15 is, for example, a time when the data transfer apparatus 15 is connected to the processor unit 1 at factory shipment of the processor unit 1. Thus, the data transfer apparatus 15 can store the identifier of the network card 11 before replacement in the first storage unit 61 as the first identifier at startup of the processor unit 1.

When the identifier is stored in the first storage unit 61 (“YES” in S103), the processing unit 52 determines whether or not the identifier obtained by the obtainment unit 51 is the same as that stored in the first storage unit 61 (S105). The time when the identifier is stored in the first storage unit 61 of the data transfer apparatus 15 is, for example, a time when the network card 11 after replacement is connected to the processor unit 1 when the network card 11 is maintained and replaced. At this time, the identifier stored in the first storage unit 61 may be, for example, the identifier of the network card 11 before replacement. Moreover, the identifier stored in the first storage unit 61 may be, for example, a dummy identifier prestored by a user.

When the identifier obtained by the obtainment unit 51 is the same as that stored in the first storage unit (“YES” in S105), the processing unit 52 terminates the identifier storage process without changing the identifier stored in the first storage unit.

Additionally, when the identifier obtained by the obtainment unit 51 is different from that stored in the first storage unit 61 (“NO” in S105), the processing unit 52 stores the identifier obtained by the obtainment unit 51 in the second storage unit 62 as the second identifier (S106). Then, the data transfer apparatus 15 terminates the identifier storage process. In 5106, when the second identifier of the network card 11 after replacement, which was connected at preceding time, is stored in the second storage unit 62, the processing unit 52 may overwrite the identifier obtained by the obtainment unit 51 as a new second identifier. Thus, only the new second identifier is stored in the second storage unit 62.

When the identifier obtained by the obtainment unit 51 is the same as that stored in the first storage unit (“YES” in S105) and the second identifier is stored in the second storage unit 62, the processing unit 52 may delete the second identifier stored in the second storage unit 62. Thus, the data transfer apparatus 15 can perform a data transfer even when the network card 11 before replacement is reconnected to the slot 16 after the network card 11 before replacement is maintained and replaced with the network card 11 after replacement.

Additionally, when the identifier obtained by the obtainment unit 51 is the same as that stored in the first storage unit (“YES” in S105) and the second identifier is stored in the second storage unit 62, the processing unit 52 may delete the second identifier stored in the second storage unit 62. Moreover, the processing unit 52 may store the identifier obtained by the obtainment unit 51 in the second storage unit 62 as the second identifier. As a result, the data transfer apparatus 15 can perform a data transfer even when the network card 1 before replacement is reconnected to the slot 16 after the network card 11 before replacement is maintained and replaced with the network card 11 after replacement.

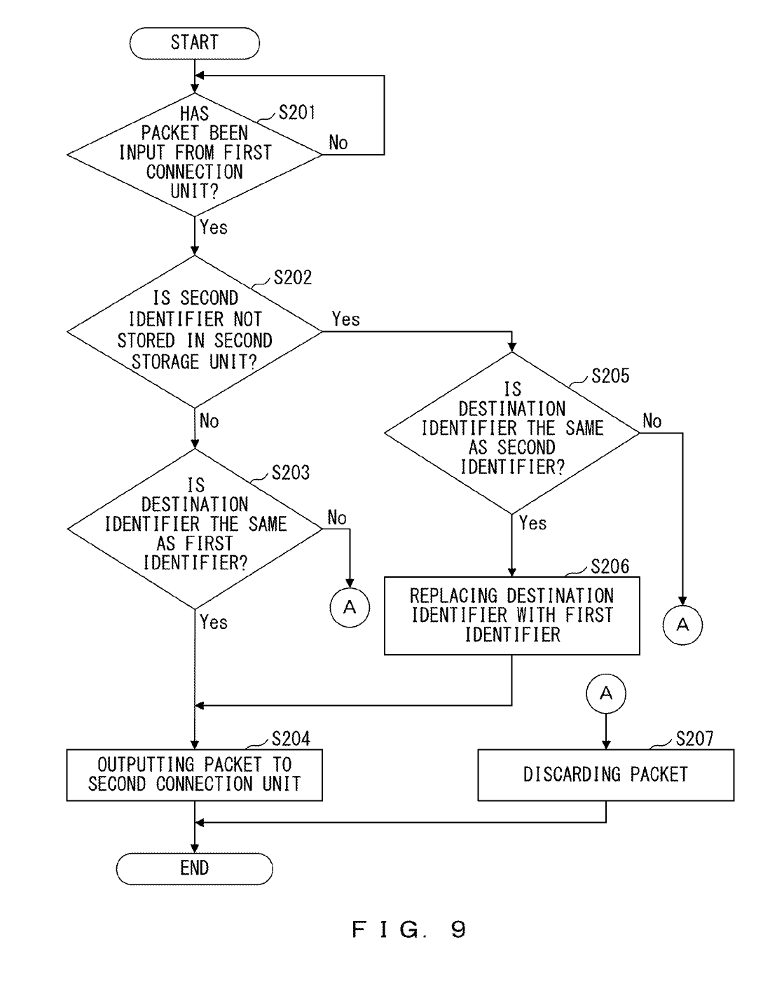

FIG. 9 is a flowchart illustrating a process executed when a packet is input from the first connection unit.

The process executed when the packet 200 is input from the first connection unit 71 is described with reference to FIG. 9. The following description assumes that the identifier storage process illustrated in FIG. 8 is terminated.

The transfer unit 53 determines whether or not the packet 200 has been input from the first connection unit 71 (S201). The time when the packet 200 has been input from the first connection unit 71 is, for example, a time when the network card 11 has received the packet 200 from the processor unit 2 or the storage unit 3, which is communicatively connected to the processor unit 1.

The transfer unit 53 repeats the process of S201 until the packet 200 is input from the first connection unit (“NO” in S201).

When the packet 200 has been input from the first connection unit 71 (“YES” in S201), the transfer unit 53 determines whether or not the second identifier is stored in the second storage unit 62 (S202).

When the second identifier is not stored in the second storage unit 62 (“NO” in S202), the transfer unit 53 determines whether or not the destination identifier of the packet 200 input from the first connection unit 71 is the same as the first identifier stored in the first storage unit 61 (S203). The time when the second identifier is not stored in the second storage unit 62 is, for example, a time when the data transfer apparatus 15 is connected to the processor unit at factory shipment and the network card 11 before replacement is connected to the data transfer apparatus 15. At this time, the identifier of the network card 11 before replacement is set in the OS 14.

When the first identifier is the same as the destination identifier (“YES” in S203), the transfer unit 53 performs a control for outputting the packet 200 to the main board 13 via the second connection unit 72 without replacing the destination identifier (S204). Then, the data transfer apparatus 15 terminates the process executed when the packet 200 has been input from the first connection unit 71.

When the destination identifier is different from the first identifier (“NO” in S203), the transfer unit 53 discards the packet 200 (S207). Then, the data transfer apparatus 15 terminates the process executed when the packet 200 has been input from the first connection unit 71.

When the second identifier is stored in the second storage unit 62 (“YES” in S202), the transfer unit 53 determines whether or not the destination identifier input from the first connection unit 71 is the same as the second identifier stored in the second storage unit 62 (S205).

When the destination identifier is the same as the second identifier (“YES” in S205), the transfer unit 53 performs a control for replacing the destination identifier with the first identifier and for outputting the packet 200 to the main board 13 via the second connection unit 72 (S206). Then, the data transfer apparatus 15 terminates the process executed when the packet 200 has been input from the first connection unit 71.

When the destination identifier is different from the second identifier (“NO” in S205), the transfer unit 53 discards the packet 200 (S207). Then, the data transfer apparatus 15 terminates the process executed when the packet 200 has been input from the first connection unit 71.

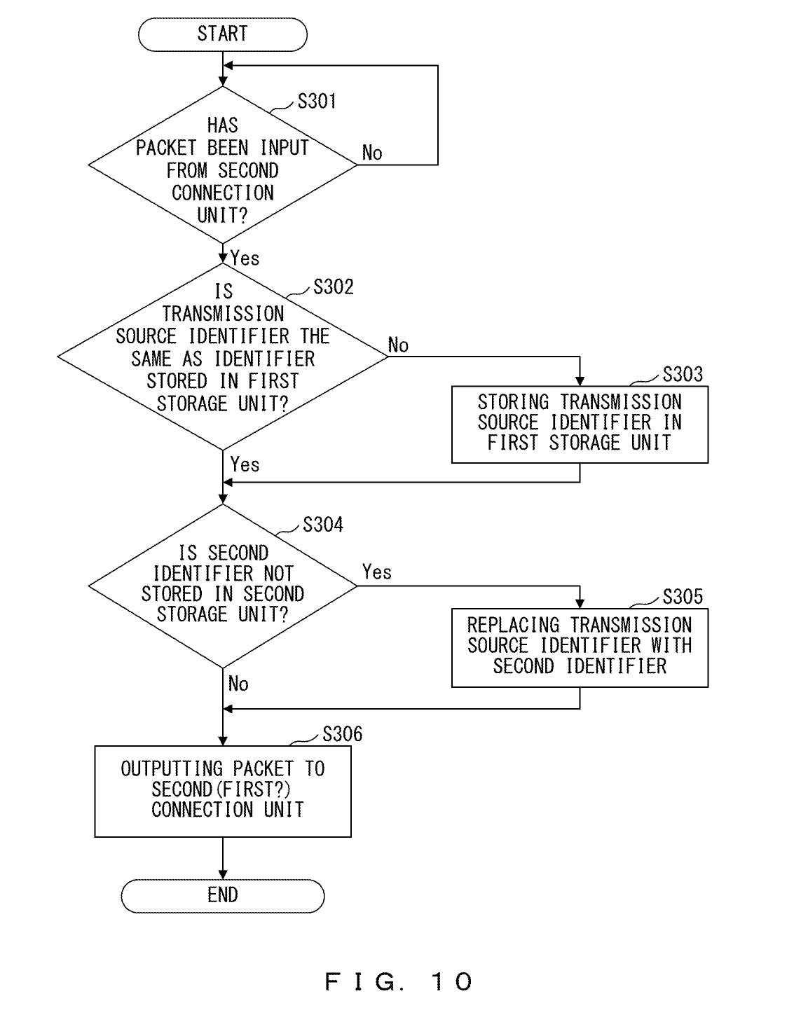

FIG. 10 is a flowchart illustrating a process executed when a packet has been input from the second connection unit. The following description assumes that the identifier storage process illustrated in FIG. 8 is terminated.

The transfer unit 53 determines whether or not the packet 200 has been input from the second connection unit 72 (S301). The time when the packet 200 is input from the second connection unit 72 is, for example, a time when the packet 200 is transmitted from the processor unit 1 to the processor unit 2 or the storage unit 3, which is communicatively connected to the processor unit 1.

When the packet 200 has been input from the second connection unit 72 (“YES” in S301), the transfer unit 53 determines whether or not the transmission source identifier of the packet 200 input from the second connection unit 72 is the same as the identifier stored in the first storage unit 61 (S302). The transmission source identifier of the packet 200 is, for example, the identifier of the network card 11 before replacement. The identifier stored in the first storage unit 61 is, for example, the first identifier or a dummy identifier.

When the transmission source identifier is the same as the identifier stored in the first storage unit 61 (“YES” in S302), the transfer unit 53 determines whether or not the second identifier is stored in the second storage unit 62 (S304). The time when the transmission source identifier is the same as the identifier stored in the first storage unit 61 is, for example, a time when the first identifier is stored in the first storage unit 61.

When the second identifier is not stored in the second storage unit 62 (“NO” in S304), the transfer unit 53 performs a control for outputting the packet 200 to the network card 11 via the first connection unit 71 without replacing the transmission source identifier (S306).

In 5302, when the transmission source identifier is different from the identifier stored in the first storage unit 61 (“NO” in S302), the transfer unit 53 notifies the processing unit 52 of the transmission source identifier and that the transmission source identifier is different from the identifier stored in the first storage unit 61. The time when the transmission source identifier is different from the identifier stored in the first storage unit 61 is, for example, a time when a dummy identifier is stored in the first storage unit 61.

When the processing unit 52 is notified of the transmission source identifier and that the transmission source identifier is different from the identifier stored in the first storage unit 61, the processing unit 52 stores the transmission source identifier in the first storage unit 61 as the first identifier (S303). At this time, the processing unit 52 may store the first identifier, for example, by overwriting the identifier stored in the first storage unit 61. As a result, only the first identifier is stored in the first storage unit 61. Then, the transfer unit 53 executes the process of S304.

In S304, when the second identifier is stored in the second storage unit 62 (“YES” in S304), the transfer unit 53 performs a control for replacing the transmission source identifier with the second identifier and for outputting the packet 200 to the network card 11 via the first connection unit 71 (S306).

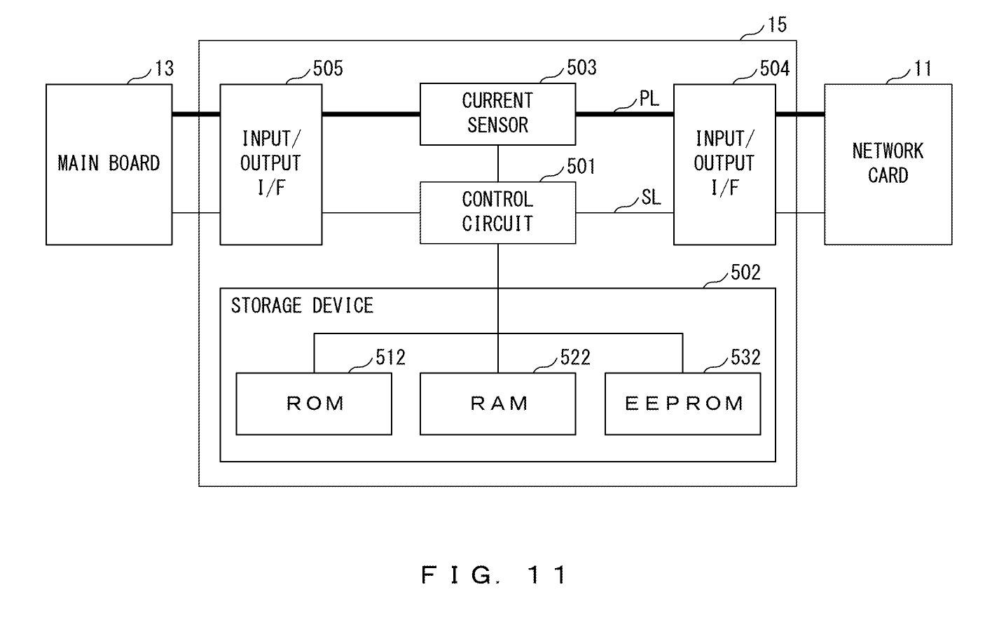

FIG. 11 is a block diagram illustrating an implementation example of the data transfer apparatus.

A configuration of the data transfer apparatus 15 is described with reference to FIG. 11.

In FIG. 11, the data transfer apparatus 15 includes a control circuit 501 (processor), a storage device 502, a current sensor 503, an input/output interface 504 (input/output I/F), and an input/output interface 505 (input/output I/F). Moreover, the components are interconnected by a signal line SL. Additionally, the current sensor 503, the input/output interface 504, and the input/output interface 505 are interconnected by a current line PL.

The control circuit 501 controls the entire data transfer apparatus 15. The control circuit 501 is, for example, a CPU, a multi-core CPU, an FPGA, a PLD (Programmable Logic Device), or the like. The control circuit 501 functions, for example, as the control unit 50 in FIG. 4.

The storage device 502 stores various types of data. The storage device 502 is configured, for example, with a memory (computer-readable recording medium) such as a ROM 512, a RAM 522, an EEPROM 532 or the like. The storage device 502 may be configured with an HD (Hard Disk). The storage device 502 functions, for example, as the storage unit 60 in FIG. 4.

Additionally, the ROM 512 stores, for example, a data transfer program that causes the control circuit 501 to operate as the control unit 50. The RAM 522 is used, for example, as a working area of the control circuit 501. The EEPROM 532 includes, for example, the first storage unit 61, and stores a first identifier and a dummy identifier. The EEPROM 532 includes, for example, the second storage unit 62, and stores a second identifier. The application purposes of the memories that configure the storage device 502 are merely examples, and their application purposes may be replaced. Moreover, data stored in the memories that configure the storage device 502 may be stored onto an HD.

When a data transfer is performed, the control circuit 501 reads, for example, the data transfer program stored in the ROM 512 into the RAM 522. Then, the control circuit 501 executes a data transfer process by executing the data transfer program read into the RAM 522.

The input/output interface 504 and the input/output interface 505 communicatively couple the data transfer apparatus 15 and another device. Moreover, the input/output interface 504 and the input/output interface 505 electrically connect the data transfer apparatus 15 and another device. The input/output interface 504 functions, for example, as the first connection unit 71 in FIG. 4. The input/output interface 505 functions, for example, as the second connection unit 72 in FIG. 4.

The current sensor 503 measures a current that flows into the current line PL. The current sensor 503 functions, for example, as the current detection unit 80 in FIG. 4.

As described above, the data transfer apparatus 15 according to the embodiment stores the first identifier, which is an identifier of the network card 11 before replacement, and the second identifier, which is an identifier of the network card 11 after replacement. When the second identifier is assigned to data input from the first connection unit 71, the data transfer apparatus 15 replaces the second identifier assigned to the data with the first identifier, and outputs the data to the main board 13 via the second connection unit 72. As a result, the data transfer apparatus 15 can make the processor unit 1 communicative with other devices without setting the identifier of the network card 11 after replacement in the OS 14 at the time of maintenance and replacement of the network card 11. Accordingly, the data transfer apparatus 15 can prevent an error from being made in a setting of an identifier of the network card 11. Moreover, the data transfer apparatus 15 eliminates the need for setting an identifier by a user, whereby maintenance and replacement operations of the network card 11 can be simplified.

The data transfer apparatus 15 according to the embodiment stores the first identifier, which is the identifier of the initially connected network card 11 before replacement, and the second identifier, which is the identifier of the network card 11 after replacement. When the first identifier is assigned to data input from the second connection unit 72, the data transfer apparatus 15 replaces the first identifier assigned to the data with the second identifier, and outputs the data to the network card 11 via the first connection unit 71. As a result, the data transfer apparatus 15 makes the processor unit 1 communicative with other devices even though a user does not set the identifier of the network card 11 after replacement in the OS 14 at the time of maintenance and replacement of the network card 11. Accordingly, the data transfer apparatus 15 can prevent an error from being made in a setting of an identifier of the network card 11.

When a dummy identifier is stored in the first storage unit 61, the data transfer apparatus 15 according to the embodiment automatically stores an identifier obtained by the obtainment unit 51 in the second storage unit 62 as the second identifier. Accordingly, the data transfer apparatus 15 can eliminate the need for setting an identifier by a user, can prevent an error from being made in a setting of an identifier, and can simplify the operations at the time of maintenance and replacement of the network card 11.

When the first identifier is stored in the first storage unit 61, the data transfer apparatus 15 according to the embodiment stores an identifier different from the first identifier obtained by the obtainment unit 51 as the second identifier. Accordingly, the data transfer apparatus 15 can eliminate the need for setting an identifier by a user, can prevent an error from being made in a setting of an identifier, and can simplify the operations at the time of maintenance and replacement of the network card 11.

When an identifier assigned to data input from the second connection unit 72 is different from the identifier stored in the first storage unit 61, the data transfer apparatus 15 according to the embodiment stores the identifier assigned to the data in the first storage unit 61 as the first identifier. Accordingly, the data transfer apparatus 15 can eliminate the need for setting an identifier by a user, can prevent an error from being made in a setting of an identifier, and can simply the operations at the time of maintenance and replacement of the network card 11.

When no identifier is stored in the first storage unit 61, the data transfer apparatus 15 according to the embodiment stores the first identifier obtained by the obtainment unit 51 in the first storage unit 61. Accordingly, the data transfer apparatus 15 can eliminate the need for setting an identifier by a user, can prevent an error from being made in a setting of an identifier, and can simply the operations at the time of maintenance and replacement of the network card 11.

All examples and conditional language provided herein are intended for the pedagogical purposes of aiding the reader in understanding the invention and the concepts contributed by the inventor to furthering the art, and are not to be construed as limitation to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data transfer apparatus, comprising:
a first connection unit configured to connect to a network card;
a second connection unit configured to connect to aboard on which a processor and a memory are mounted;
the processor configured to execute a process of obtaining an identifier of the network card connected to the first connection unit;
a first storage unit configured to store a first identifier obtained by the processor; and
a second storage unit configured to store a second identifier different from the first identifier obtained by the processor, wherein
the process executed by the processor further includes
replacing the second identifier assigned to data input from the first connection unit with the first identifier and outputting the data via the second connection unit, when the second identifier is assigned to the data.

2. The data transfer apparatus according to claim 1, wherein
the process executed by the processor further includes
discarding the data when an identifier different from the second identifier is assigned to the data input from the first connection unit.

3. The data transfer apparatus according to claim 1, wherein
the process executed by the processor further includes
outputting the data via the second connection unit without replacing the first identifier assigned to the data when the second identifier is not stored in the second storage unit and the first identifier is assigned to the data input from the first connection unit.

4. The data transfer apparatus according to claim 1, wherein
the process executed by the processor further includes
discarding the data when the second identifier is not stored in the second storage unit and an identifier different from the first identifier is assigned to the data input from the first connection unit.

5. The data transfer apparatus according to claim 1, wherein
the process executed by the processor further includes
replacing the first identifier assigned to the data with the second identifier and outputting the data via the first connection unit, when the first identifier is assigned to the data input from the second connection unit.

6. The data transfer apparatus according to claim 1, wherein
the process executed by the processor further includes
outputting the data via the first connection unit without replacing the first identifier assigned to the data when the second identifier is not stored in the second storage unit and the first identifier is assigned to the data input from the second connection unit.

7. The data transfer apparatus according to claim 1, wherein
the process executed by the processor further includes
storing the second identifier different from a dummy identifier obtained by the processor in the second storage unit when the dummy identifier different from the identifier of the network card is stored in the first storage unit.

8. The data transfer apparatus according to claim 7, wherein
the process executed by the processor further includes
storing the second identifier different from the first identifier obtained by the obtainment unit in the second storage unit when the first identifier is stored in the first storage unit.

9. The data transfer apparatus according to claim 7, wherein
the process executed by the processor further includes
storing an identifier assigned to the data input from the second connection unit in the first storage unit when the identifier assigned to the data input from the second connection unit is different from the identifier stored in the first storage unit.

10. The data transfer apparatus according to claim 7, wherein
the process executed by the processor further includes
storing the first identifier obtained by the obtainment unit in the first storage unit when no identifier is stored in the first storage unit.

11. A data transfer method executed by a processor of a data transfer apparatus including a first connection unit connected to a network card, a second connection unit connected to a board on which the processor and a memory are mounted, a first storage unit and a second storage unit, wherein
the processor executes a process including:
obtaining a first identifier of a first network card connected to the first connection unit;
storing the obtained first identifier in the first storage unit;
obtaining a second identifier different from the first identifier of a second network card connected to the first connection unit when the first identifier is stored in the first storage unit;
storing the obtained second identifier in the second storage unit; and
replacing the second identifier assigned to the data with the first identifier and outputting the data via the second connection unit, when the second identifier is assigned to the data input from the first connection unit.

12. The data transfer method according to claim 11, wherein
the process further includes
replacing the first identifier assigned to the data with the second identifier and outputting the data via the first connection unit, when the first identifier is assigned to the data input from the second connection unit.

13. The data transfer method according to claim 11, wherein
the process further includes
storing the second identifier different from a dummy identifier obtained by the processor in the second storage unit when the dummy identifier different from the identifier of the network card is stored in the first storage unit.
